(19) United States
(12) Patent Application Publication
(10) Pub. No.: US 2009/0145856 A1
(43) Pub. Date: Jun. 11, 2009

(54) Acid recycle process with iron removal

(76) Inventors: Letize A. Raymond, West Haven, CT (US); Leonetti J. Stephen, Woodbury, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/001,317

(22) Filed: Dec. 11, 2007

(51) Int. Cl. B01D 11/02; C02F 1/68; C02F 1/52

(52) U.S. Cl. 210/749; 210/198.1; 210/724; 210/205; 210/206; 210/194

(57) ABSTRACT

A method and system for removing contaminating iron from an acid pickle bath. The method comprises the steps of removing at least a portion of the acid pickle solution containing an amount of contaminating iron therein from a primary acid pickle bath, raising the pH of the at least the portion of the acidified acid copper solution with a pH adjuster to a level which is conducive to the precipitation of iron, precipitating the contaminating iron from the acidified acid copper solution, and acidifying the acid copper solution back to operating conditions for the system. Once the portion of the acid pickle solution has been treated, it is returned to the primary acid pickle bath.

### FIELD OF THE INVENTION

The present invention relates to a process for removing contaminating iron in an acid copper pickle bath.

### BACKGROUND OF THE INVENTION

Various metal cleaning compositions are typically used in the metal finishing industry, including (1) halogenated and non-halogenated solvents, (2) alkaline cleaners, (3) electrocleaning, and (4) acid cleaners.

Acid pickling is used to remove contaminants such as oxides (i.e., rust), scale, and tarnish from a metal workpiece as well as to neutralize any base remaining on the workpiece. Acid pickling typically uses aqueous solutions of sulfuric, hydrochloric, phosphoric, and/or nitric acid.

The copper rod mill industry uses acidified acid copper sulfate solutions to clean and remove oxide from casted, rolled and annealed copper, which is extruded from a high temperature melt and pulled through cast wheels to produce the proper diameter material for sale. The removal of surface scale by the acidified acid copper sulfate solution involves a chemical reaction of the scale and the copper surface with the use of sulfuric acid or hydrochloric acid. In the pickling step, the copper workpiece is immersed in the acid bath which dissolves the scale and as well dissolves iron. After a period of time, the copper is removed from the acid bath and residual acid is rinsed from the copper.

As the iron content in the pickling acid bath increases, the pickling efficiency is reduced and fresh acid must be added to the bath to maintain an effective reaction rate. Iron contamination can come from various sources, including for example, steel wheels where galling of iron can result, the copper alloy itself, tank materials, and other handling procedures.

Once the iron builds to an unacceptable concentration, the ferric iron in combination with sulfate (and sometimes chloride contamination) can become an aggressive copper etchant. Eventually, the iron content becomes excessive for effective pickling and the spent pickle liquor must be replaced with fresh acid.

Various methods have been suggested for treating spent pickle liquor in these processes, including acid recovery and neutralization.

Acid recovery involves the crystallization of iron salts (such as ferrous sulfate) from the spent liquor and the addition of enough fresh sulfuric acid to return the pickling bath to its original acid strength. The solubility of iron salts in the pickle liquor is such that crystallization can be induced by cooling or by evaporating water from the solution. When the dissolved iron and the sulfuric acid content of the pickling solution reach a predetermined level, the contents of the pickling bath are pumped to a crystallizer and the pickling tank is recharged with recovered acid from a previous batch before pickling is resumed. One of the drawbacks of this process is that a long period of time (i.e., at least 8 to 16 hours) is required to slowly reduce the temperature to precipitate the iron.

Other methods that have been suggested for treating acid streams include an electrolytic process for recovering metallic iron from spent liquor and regenerating sulfuric acid for use in subsequent operations, as discussed in U.S. Pat. No. 4,149,946 to Burke and a process for precipitating iron as jarosite by oxidation and hydrolysis of ferrous sulfate in the presence of alkali metal or ammonium ions, as discussed in U.S. Pat. No. 4,193,970 to Sefton et al., the subject matter of each of which is herein incorporated by reference in its entirety. However, both of these process require significant additional processing steps and equipment.

Thus, it would be desirable to provide a process from the treatment of spent pickle liquor that overcomes many of the deficiencies of the prior art that is capable of treating spent pickle liquor more efficiently with fewer processing steps.

### SUMMARY OF THE INVENTION

It is an object of the present invention to provide a process for treating spent pickle liquor.

It is another object of the present invention to provide a process for treating spent pickle liquor that does not require significant additional time and processing equipment.

It is another object of the present invention to provide a process for treating an iron contaminated acid pickle solution that allows the acid pickle solution to be reused and recycled.

To that end, the present invention relates generally to a method of removing contaminating iron from an acid pickle bath comprising the steps of:
a) removing at least a portion of an acid pickle solution containing an amount of contaminating iron therein from a primary acid pickle bath;
b) raising the pH of the at least portion of the acid pickle solution with a pH adjuster to a pH of between about 4 and 4.5 which is conducive to the precipitation of iron;
c) precipitating the contaminating iron from the at least portion of the acid pickle solution;
d) separating the precipitated iron from the acid pickle solution; and
e) acidifying the treated acid pickle solution back to operating conditions for the primary acid pickle bath.

### BRIEF DESCRIPTION OF THE DRAWINGS

FIG. 1 depicts a schematic of an acid pickle regeneration process in accordance with one embodiment of the present invention.

### DETAILED DESCRIPTION OF THE PREFERRED EMBODIMENTS

The present invention relates to a novel process for the removal of contaminating iron from an acid pickle solution in a primary acid pickle bath.

The present invention involves the selective removal of iron on a batch or continuous basis from an iron contaminated acid pickle solution comprising an acid copper sulfate solution. A portion of the primary pickle bath is pH adjusted to effectively precipitate all of the contaminating iron without any substantial change in the copper concentration.

As discussed above, copper slowly builds in the system due to dissolution of the oxide surface in an acid environment. Once the iron is fully precipitated, it can be removed by filtering, decantation, pressing or other methods that would be well known to those skilled in the art. The solution is then pH adjusted or free acid analyzed (sulfuric acid) and brought back to specification for continued uniform and mild deoxidation and is then returned to the primary acid pickle bath.

In one embodiment, the present invention relates to a method of removing contaminating iron from an acid pickle bath comprising the steps of:
a) removing at least a portion of an acid pickle solution containing an amount of contaminating iron therein from a primary acid pickle bath;
b) raising the pH of the at least the portion of the acid pickle solution with a pH adjuster to a pH between about 4 and 4.5 which is conducive to the precipitation of iron;
c) precipitating the contaminating iron from the acid pickle solution;
d) separating the precipitated iron from the acid pickle solution; and
e) acidifying the treated acid pickle solution back to operating conditions for the primary acid pickle bath and returning it to the primary acid pickle bath.

The pH adjuster is preferably selected from potassium carbonate, potassium hydroxide, calcium carbonate, calcium hydroxide, and combinations of one or more of the foregoing. In a preferred embodiment, the pH adjuster is potassium carbonate or potassium hydroxide.

Once the contaminating iron has been precipitated, the portion of the treated acid pickle bath is returned to the primary acid pickle bath.

The treated acid pickle solution typically contains less than about 10 ppm of contaminating iron, and more preferably less than about 3 ppm of contaminating iron.

A further step involves filtering and removing the precipitated iron from the acid pickle solution before it is acidified and returned to the primary acid pickling bath.

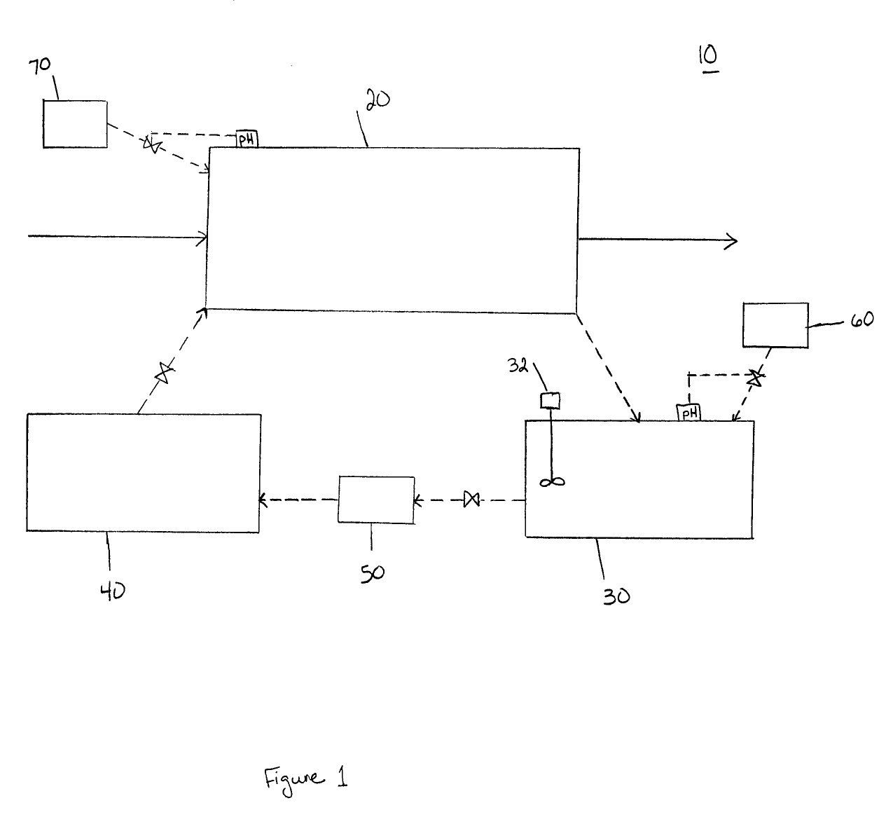

A schematic of an acid pickle bath regeneration process in accordance with one embodiment of the present invention is provided in FIG. 1.

The acid pickle regeneration process 10 of the invention comprises a primary acid pickle bath 20 which holds a volume of an acid copper pickle solution. In one embodiment, the acid copper pickle bath comprises about 68 g/L CUSO₄.5H₂O (copper sulfate pentahydrate) and 0.5-1.0% H₂SO₄ and is maintained at a pH of between about 1 and 1.5, more preferably about 1.2.

Once the acid pickle bath 20 becomes contaminated with iron, typically to a level above about 300 ppm iron, a portion of the acid pickle solution is removed from the primary acid pickle bath 20 to the reaction tank 30. Any suitable means may be used to remove the portion of the acid pickle solution to the reaction tank 30. For example, the portion of the acid pickle solution may be gravity fed to the reaction tank 30. While the portion of the acid pickle solution that is removed is not critical, the portion typically comprises at least about 5% of the total volume of the acid pickle bath, and preferably comprises about 10% of the total volume of the acid pickle bath. Thus, for example if the acid pickle bath contains about 5000 gallons, about 500 gallons may be removed for treatment at a given time.

Once the portion of pickle solution has been removed to the reaction tank 30, the portion is pH controlled to a pH of between 4 and 4.5, more preferably to a pH of about 4.2 to cause the iron to precipitate. Suitable mixing means 32 are used to agitate the solution for a sufficient period of time. In one embodiment, the solution is mixed for between 30 minutes and 2 hours, more preferably for about 1 hour. The pH of the reaction tank 30 may be continuously monitored and adjusted and a source of alkali 60 is added to the reaction tank 30 to adjust the pH. In one embodiment, the alkali is a 9.1 N solution of potassium hydroxide or potassium carbonate. Once the acid pickle solution has been adequately mixed, it is allowed to settle for a period of time to precipitate out the contaminating iron. The acid pickle solution may be allowed to settle for between about 2 and about 5 hours, more preferably for about 3 hours.

Thereafter the treated acid pickle solution may then be pumped through a filter press 50 or other suitable filtering means to remove the precipitated iron and the resulting treated solution is transferred to a holding reservoir 40 where acid can be added to decrease the pH to that of the primary acid pickle bath. As the primary acid pickle bath 20 gets depleted and portions of the acid pickle solution are removed, additional treated pickle solution is pumped into the primary acid pickle bath 20 from the holding reservoir 40. The pH of the primary acid pickle bath 20 is continuously measured and monitored and sulfuric acid is added as needed to maintain the pH of the primary pickle bath at a pH of about 1.2.

### EXAMPLES

A 68 g/l solution of copper sulfate pentahydrate containing 1% sulfuric acid (pH 1.2) and 500 mg/L Fe³⁺ was pH adjusted and allowed to stir for one hour and then settle for 3 hours. The initially blue/green solution separated out a yellow-brown precipitate (Fe(OH)₃) leaving a crystal clear blue solution. A pH adjustment back to 1.2 with sulfuric acid was then performed on the solution.

A copper foil etch rate was performed before and after iron removal. The appearance of each copper foil was observed and a scanning electron microscope (SEM) photograph was taken. There was no difference observed in the etch rate or appearance of the regenerated solution versus a brand new make-up solution. The SEM photographs were also equivalent. However, there was a significant difference in etch rate, appearance, and SEM photographs between the regenerated (recycled) solution and the iron-contaminated solution.

### Example 1

A brand new acid pickle bath was prepared having the following composition:
68 g/L copper sulfate pentahydrate aqueous solution
pH—1.42
1% sulfuric acid
A 3″×3″ rate and appearance panel was run under the following conditions:

| | |
|---|---|
| Temperature: | 140° F. |
| Dwell time: | 1 minute |
| Microinches removed: | 1-2 |
| Rate panel appearance: | reflective and lustrous |

The rate and appearance panel was prepared as follows:

1) The 3″×3″ panel was weighed;

2) Acid copper plating;

3) Cleaning (i.e., with OmniClean® CI)

4) Neutralizing (i.e., with M-Neutralize®)

5) Acid Pickle

6) Dry, weigh, observe appearance and SEM photograph

### Example 2

A contaminated acid pickle bath was prepared having the following composition:
68 g/L copper sulfate pentahydrate aqueous solution
pH—1.42
1% sulfuric acid
500 mg/L Fe³⁺
A 3″×3″ rate and appearance panel was run under the following conditions:

| | |
|---|---|
| Temperature: | 140° F. |
| Dwell time: | 1 minute |
| Microinches removed: | 10-12 |
| Rate panel appearance: | hazy and dull |

### Example 3

Example 2 was recycled to remove the iron contamination in accordance with the present invention. The pH was raised to 4.2 with potassium carbonate or potassium hydroxide, mixed for 1 hour, settles for 3 hours, and the solution poured off through a Whatman medium filter paper. Iron analysis by AA was less than 5 mg/L. The pH was then lowered to 1.42 with sulfuric acid. The purified solution was heated to 140° F. and a rate coupon processed for rate and appearance for comparison. The rate and appearance was similar to Example 1.

While the invention has been described above with reference to specific embodiments thereof, it is apparent that many changes, modifications, and variations can be made without departing from the inventive concept disclosed here. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method of removing contaminating iron from an acid pickle solution in a primary acid pickle bath comprising the steps of:
a) removing at least a portion of the acid pickle solution containing an amount of contaminating iron therein from the primary acid pickle bath;
b) raising the pH of the at least the portion of the acid pickle solution with a pH adjuster to a pH between about 4 and 4.5 which is conducive to the precipitation of iron;
c) precipitating the contaminating iron from the at least portion of the acid pickle solution;
d) separating the precipitated iron from the acid pickle solution; and
e) acidifying the at least the portion of the acid pickle solution back to operating conditions for the primary acid pickle bath.

2. The method according to claim 1, wherein the pH adjuster is selected from the group consisting of potassium carbonate, potassium hydroxide, calcium carbonate, calcium hydroxide, and combinations of one or more of the foregoing.

3. The method according to claim 1, wherein the concentration of contaminating iron remaining in the at least the treated portion of the acid pickle solution is less than about 10 ppm.

4. The method according to claim 1, wherein the primary acid pickle bath is maintained at a temperature of about 130 to 150° F.

5. The method according to claim 1, wherein the pH level of the at least the portion of the acid pickle bath is raised to about 4.2.

6. The method according to claim 1, wherein the step of acidifying the acid pickle solution back to the operating conditions of the primary acid pickle bath comprises adding sulfuric acid to the acid pickle solution.

7. The method according to claim 6, wherein the operating conditions for the primary acid pickle bath comprises a pH of between about 1 and 1.5.

8. The method according to claim 7, wherein the operating conditions for the primary acid pickle bath comprises a pH of about 1.2.

9. The method according to claim 1, wherein the acid pickle bath comprises about 68 g/L CuSO₄.5H₂O and about 0.5 to about 1% by weight sulfuric acid.

10. The method according to claim 1, comprising the step of filtering the precipitated iron from the at least the portion of the acid pickle solution.

11. A regeneration system for regenerating an acid pickle bath that comprises an amount of contaminating iron, the system comprising:
a primary acid pickle bath containing a volume of an acid pickle solution;
means for removing at least a portion of the acid pickle solution from the primary acid pickle bath;
a reaction tank for precipitating iron from the removed portion of the acid pickle solution, said reaction tank comprising mixing means and pH adjusting means to raise the pH of the portion of the acid pickle solution to a pH between about 4 and 4.5 that is conducive to the precipitation of iron;
a means for separating the precipitated iron from the acid pickle solution;
a holding reservoir for housing the at least the portion of the treated acid pickle solution prior to recycling back into the primary acid pickle bath; and
a means for adding acid to the acid pickle solution.

12. The system according to claim 11, comprising pumping means for pumping the treated pickle solution from the holding reservoir into the primary acid pickle bath.

13. The system according to claim 11, wherein the primary acid pickle bath contains a pH adjustment means for maintaining the pH of the acid pickle solution at a suitable level.

14. The system according to claim 11, comprising filtering means for filtering the treated acid pickle solution after the iron has been precipitated from the at least the removed portion of the acid pickle solution.
